(19) United States
(12) Patent Application Publication
(10) Pub. No.: US 2006/0219227 A1
(43) Pub. Date: Oct. 5, 2006

(54) Toroidal intersecting vane supercharger

(76) Inventor: Eric Ingersoll, Cambridge, MA (US)

Correspondence Address: ELMORE PATENT LAW GROUP, PC, 209 MAIN STREET, N. CHELMSFORD, MA, 01863, US

(21) Appl. No.: 11/099,217

(22) Filed: Apr. 5, 2005

(51) Int. Cl. F02B 33/00; F02B 53/04; F01C 1/00; F04C 18/00; F02B 33/44

(52) U.S. Cl. 123/559.1; 123/221; 60/611; 418/207

(57) ABSTRACT

The invention relates to the discovery that employing a toroidal intersecting vane machine (TIVM) within the internal combustion engine provides substantial improvements in controlling pressure, air pressure and air flow into an engine, while maintaining a simplified mechanical system and providing a compressor with little or no parasitic load on the engine. This invention covers the use of the TIVM for the purpose of providing this control.

### BACKGROUND OF THE INVENTION

The invention relates to a supercharger and turbocharger for an internal combustion engine. Turbochargers are described in U.S. Pat. No. 6,854,272 and U.S. Ser. No. 60/559,010 to Kopko, for example, which are incorporated herein by reference. The turbocharger comprises a compressor, which is arranged in the induction system of the internal combustion engine and is connected by means of a shaft to an exhaust gas turbine located in the exhaust system of the internal combustion engine, which exhaust gas turbine is driven by the exhaust gases, of the internal combustion engine, which are at an increased exhaust gas back pressure. The compressor then induces ambient air (and or other gasses) and compresses the latter to an increased boost pressure, at which the combustion air is supplied to the internal combustion engine. A supercharger is a compressor, fulfilling the same function as a turbocharger, but driven mechanically by the engine.

It is desirable to have extensive control over the pressure and amount of intake gasses, hereafter, air flowing into an engine, to exercise this control while maintaining as simple a mechanical system as possible and to increase the pressure of the air going into the engine. Furthermore, it is also desirable to be able to drive the compressor making this compressed air with little or no parasitic load on the engine. It is also desirable to boost the pressure of the air entering the engine at low rpm, this is difficult for turbochargers, and is one of the reasons superchargers are used instead. As engine developers and packagers use increasingly more sophisticated and turbomachinery to affect this control, the systems are also growing and complexity. There exists a need to meet these objectives, yet avoid complex systems.

### SUMMARY OF THE INVENTION

The invention relates to the discovery that employing a toroidal intersecting vane machine (TIVM) within the internal combustion engine provides substantial improvements in controlling pressure, air pressure and air flow into an engine, while maintaining a simplified mechanical system and providing a compressor with little or no parasitic load on the engine. This invention covers the use of the TIVM for the purpose of providing this control.

The benefits of this invention include
(1) better match between the output pressure from the supercharger and the boost pressure desired for the engine over the full operating range of the engine,
(2)reduced power requirement for the same mass flow (as compared with existing superchargers),
(3) excellent transient response from the compressor and the expander,
(4)the ability to pump multiple gases with the same compressor at the same or varying pressure ratios (thereby providing improvements in exhaust gas recirculation and pumping crankcase gases),
(5) good to excellent match between the operating RPM of the compressor and the RPM of the engine,
(6) good to excellent match between the RPM of the expander and the RPM of the engine,
(7) the ability to mount the compressor and/or expander on the main crankshaft of the engine,
(8) the ability to vary the pressure ratio of the compressor and expander to match engine requirements overbroad operating range,
(9) the ability to employ higher pressure ratios than can be achieved with traditional turbomachinery, and
(10) the ability to further increase engine efficiency through a turbo compound arrangement, for example.

The invention, therefore relates to internal combustion engines, such as supercharged internal combustion engines, that employ one or more toroidal intersecting vane machines to provide air flow, air compression and/or air expansion in combination with a combuster.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of an internal combustion engine according to the invention.

### DETAILED DESCRIPTION OF THE INVENTION

The invention relates to an internal combustion engine system comprising a toroidal intersecting vane machine (compressor and/or expander) in combination with a combuster. In a preferred embodiment, the invention comprises an internal combustion engine comprising a combuster (such as one or more cylinders, each cylinder providing a combustion chamber and one or more fuel delivery systems (such as injectors) in communication with said cylinder(s), capable of injecting fuel into each said combustion chamber); an air intake line operatively connected to the combuster and to a toroidal intersecting vane compressor, to provide compressed air to the combustion chamber(s) from the compressor; an exhaust line also operatively connected to the combuster, to receive exhaust gas from the combustion chamber(s); and a main crank shaft functionally attached to and driven by said combuster.

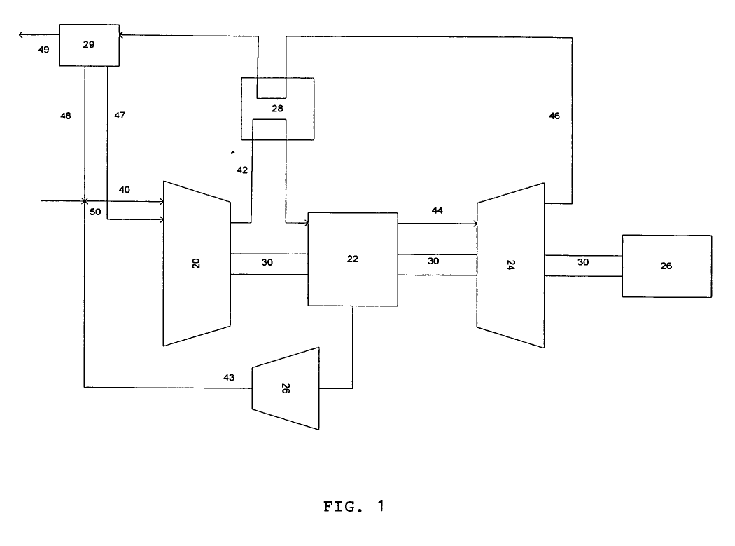

FIG. 1 illustrates the embodiment of the invention. Air is provided to the compressor 20 via an intake line 40. The air can be fresh air or recirculated air, as can be provided from crankcase gas or exhaust, or some combination thereof. Further, the air can be provided at atmospheric pressure or compressed (e.g. via a toroidal intersecting vane machine) and at ambient temperature, heated (as can occur upon compression) or cooled (e.g., via a heat exchanger or regenerator).

The compressor 20 is preferably a toroidal intersecting vane machine (TIVM). Toroidal intersecting vane machines suitable for use in the invention include those described in U.S. application Ser. No: 10/744,230, filed on Dec. 22, 2003, which is incorporated herein by reference. In particular, the TIVM comprises a first rotor and at least one intersecting secondary rotor, wherein:

(a) said first rotor has a plurality of primary vanes positioned on a radially inner peripheral surface of said first rotor, with spaces between said primary vanes and said inside surface of said supporting structure defining a plurality of primary chambers;

(b) an intake port which permits flow of air into said primary chamber and an exhaust port which permits exhaust of compressed air out of said primary chamber;

(c) said secondary rotor has a plurality of secondary vanes positioned on a radially outer peripheral surface of said secondary rotor, with spaces between said secondary vanes and said inside surface of said supporting structure defining a plurality of secondary chambers;

(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and

(e) wherein the secondary vanes positively displace the primary chambers and pressurize the fluid in the primary chambers.

In another embodiment, the above rotors are configured to permit the primary vanes to positively displace the secondary chambers and pressurize fluid in the secondary chambers.

An advantage in using the TIVM as the compressor in the invention lies in the great flexibility of the rotation speeds of the TIVM in producing a targeted pressure or ratio of compression. Thus, compressor rotation speeds approximating the rotation speed of the main crank shaft of the combuster are possible. Thus, in one embodiment of the invention, the toroidal intersecting vane compressor 20 further comprises a compressor rotor shaft 30 through the axis of rotation of the first rotor wherein the compressor rotor shaft 30 drives the compressor 20 and/or the compressor rotor shaft 30 is the main crank shaft 30. This configuration permits efficiency in engine size, communication between the rotating shafts, thereby permitting the main crank shaft shaft 30 (e.g., via the combuster 22) to drive the compressor. It may be desirable in some embodiments of the invention to add a speed reducer or speed increaser to provide optimal turning speeds for the compressor and main crankshaft.

The TIVM preferably has a plurality of secondary rotors which can be configured to provide multi-stage compression (achieved by directing the pressurized exhaust from one chamber into a second or subsequent chamber to be further compressed), as described in PCT/US2003/42904 filed on Dec. 21, 2004. In another embodiment, the compressor, characterized by a plurality of secondary rotors, can be configured to produce compressed intake air at two or more distinct pressure ratios, in series or in parallel. Where the compressor is a multi-stage compressor or where two or more compressors are employed, efficiency can be further effected by cooling the air between compression stages.

It is common practice to compress air to pressures between about 1.5 atm and 2 atm for internal combustion engines and up to about 3 atm in larger or diesel engines. This invention contemplates compressing the air (or other gas) to such pressures. Higher pressures can also be advantageously achieved. Optionally, the TIVC has a rotation speed of matching the common rotational speeds of internal combustion engines.

The compressor 20 can be attached to and driven by an electric motor or generator 26 which can be conveniently mounted on or attached to the main crank shaft 30. This permits start-up and control of the compressor independent from the combuster. Alternatively, the compressor and/or expander and/or generator, discussed herein, can be attached to a shaft other than the main crank shaft.

Compressed air exits the compressor via line 42, through an optional intercooler or regenerator 28 to cool the compressed and, thereby heated, air. The compressed air is directed to the combuster 22. The combuster 22 can be a typical combuster, such as one having one or more cylinders with a combustion chamber and one or more fuel supply systems in communication with said cylinder(s), capable of injecting fuel into each said combustion chamber. The fuel can then be combusted (e.g., by compression in the case of a diesel engine or by ignition). The combustion produces work, e.g., by rotating the main crank shaft 30. Exhaust gases are then directed from the combuster via exhaust line 44.

The system of the invention can further comprise, in addition or as an alternative to the toroidal intersecting vane compressor, a toroidal intersecting vane expander 24 operatively connected to exhaust line 44. Like the TIVC, the toroidal intersecting vane expander (TIVE) can comprise a first rotor and at least one intersecting secondary rotor, wherein:

(a) said first rotor has a plurality of primary vanes positioned on a radially inner peripheral surface of said first rotor, with spaces between said primary vanes and said inside surface of said supporting structure defining a plurality of primary chambers;

(b) an intake port which permits flow of exhaust gas into said primary chamber and an exhaust port which permits exhaust of expanded exhaust gas out of said primary chamber;

(c) said secondary rotor has a plurality of secondary vanes positioned on a radially outer peripheral surface of said secondary rotor, with spaces between said secondary vanes and said inside surface of said supporting structure defining a plurality of secondary chambers;

(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and

(e) wherein the primary vanes positively displace the secondary vanes and expand the exhaust gas in the primary chambers.

In another embodiment, the above rotors of the TIVE are configured to permit the primary vanes to positively displace the secondary chambers and pressurize fluid in the secondary chambers.

Like the TIVC, an advantage in using the TIVM as the expander in the invention lies in the great flexibility of the rotation speeds of the TIVM in producing a targeted pressure or expansion ratio. Thus, expander rotation speeds approximating the rotation speed of the main crank shaft of the combuster are possible. Thus, in one embodiment of the invention, the toroidal intersecting vane expander 24 further comprises an expander rotor shaft 30 through the axis of rotation of the first rotor wherein the expander rotor shaft 30 is driven be the expander 22 and/or the expander rotor shaft 30 is the main crank shaft 30. This configuration permits efficiency in engine size, communication between the rotating shafts, thereby permitting the main crank shaft 30 to be further driven by the expander and/or to drive the compressor. It may be desirable in some embodiments of the invention to add a speed reducer or speed increaser to provide optimal turning speeds for the expander and main crankshaft.

The TIVM preferably has a plurality of secondary rotors which can be configured to provide multi-stage expansion (achieved by directing the expanded exhaust from one chamber into a second or subsequent chamber to be further expanded), as described in PCT/US2003/42904 filed on Dec. 21, 2004. In another embodiment, the expander, characterized by a plurality of secondary rotors, can be configured to produce expanded intake air at two or more distinct pressure ratios, in series or in parallel. Where the expander is a multi-stage expander or where two or more expanders are employed, efficiency can be further affected by heating the air between expansion stages. For example, the cooled air resulting from expansion can be directed to an intercooler or regenerator 28 via exhaust line 46 and used to cool the heated compressed air in line 42, for example allowing the charge air for the engine to be cooled below ambient temperature. In another embodiment, the cooled air coming from the intercooler 28 can be further expanded to provide cooling to the engine, reducing peak combustion temperatures, increasing power density (mass flow) and reducing compression work in the cylinder. It is often desirable to expand the exhaust gas to ambient pressure or the pressure of the intake air in line 40.

The expander 24 can be attached to and drive a generator 26, which can be conveniently mounted on or attached to the main crank shaft 30.

In one embodiment, the system includes one or more superchargers 29, such as a supercharger described in U.S. Ser. No. 60/559,010 to Kopko, which is incorporated herein by reference in its entirety. It is particularly preferred that such superchargers employ TIVMs as the compressors and/or expanders.

In a particularly preferred embodiment, at least a portion of the exhaust gas from the combuster is directly or indirectly (e.g., via the expander 24) introduced into the air intake line 40 of the system. This can be accomplished by, for example, directing a recirculation line 48 of a portion of said exhaust gas to said air intake line 40. An EGR control valve 50 operated so as to control the concentration of recirculated exhaust gas and air can be advantageously added. Typically, between 10 and 30% of the total intake gas directed into the compressor 20 is recirculated exhaust gas.

In yet another embodiment, exhaust gas can be directed to the compressor prior to mixing with the intake air via line 47. In this embodiment, one or more rotors of the TIVC can be dedicated to compressing exhaust gas independently of compressing air. The compressed exhaust gas and air can be subsequently mixed for combustion. Thus, by way of example, two or three rotors can compress exhaust while six or more compressors can compress air. This embodiment provides an alternative method for controlling recirculation.

The system can include a controller (e.g., a computer) that controls at least one of the quantity of fuel injected, the quantity of recirculated exhaust gas, the quantity of air, the pressure of recirculated exhaust gas, and/or the pressure of air.

In yet another embodiment, crankcase gas can be removed from the combuster and recirculated via line 43 to intake air line 40. This gas can be advantageously pumped via a TIVC 26, as described herein. Indeed, combination of the TIVC 20 and TIVC 26 and/or the TIVE 24 into a single TIVM providing a single machine that manages multiple (or all) gas flow within the engine or system is possible.

Alternatively embodiments of the invention include by-pass valves that permit avoiding supercharging the intake gas when it is unnecessary.

While this invention has been particularly shown and described with references to preferred embodiments thereof, it will be understood by those skilled in the art that various changes in form and details may be made therein without departing from the scope of the invention encompassed by the appended claims.

What is claimed is:

1. An internal combustion engine system comprising:
a combuster;
one or more fuel supply systems in communication with said combuster, capable of injecting fuel into each said combustion chamber;
an air intake line operatively connected to the combuster and to a toroidal intersecting vane compressor, to provide compressed air to the combustion chamber(s) from the compressor;
an exhaust line also operatively connected to the combuster, to receive exhaust gas from the combustion chamber(s); and
a main crank shaft functionally attached to and driven by said combuster.

2. The system according to claim 1, wherein the toroidal intersecting vane compressor comprises a first rotor and at least one intersecting secondary rotor, wherein:
(a) said first rotor has a plurality of primary vanes positioned on a radially inner peripheral surface of said first rotor, with spaces between said primary vanes and said inside surface of said supporting structure defining a plurality of primary chambers;
(b) an intake port which permits flow of air into said primary chamber and an exhaust port which permits exhaust of compressed air out of said primary chamber;
(c) said secondary rotor has a plurality of secondary vanes positioned on a radially outer peripheral surface of said secondary rotor, with spaces between said secondary vanes and said inside surface of said supporting structure defining a plurality of secondary chambers;
(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and
(e) wherein the secondary vanes positively displace the primary chambers and pressurize the fluid in the primary chambers.

3. The system according to claim 2, wherein the toroidal intersecting vane compressor further comprises a compressor rotor shaft through the axis of rotation of the first rotor wherein the compressor rotor shaft drives the compressor.

4. The system according to claim 3, wherein the compressor rotor shaft is the main crank shaft.

5. The system according to claim 2, wherein the toroidal intersecting vane compressor comprises a plurality of secondary rotors and is configured as a multistage compressor.

6. The system according to claim 5, wherein compressed air is cooled between compression stages.

7. The system according to claim 2, wherein the toroidal intersecting vane machine comprises a plurality of rotors and is configured to produce compressed intake air at two or more distinct pressure ratios.

8. The system according to claim 3, wherein the compressor is functionally attached to and driven by an electric motor.

9. The system according to claim 1 further comprising a toroidal intersecting vane expander operatively connected to said exhaust line.

10. The system according to claim 5, wherein the toroidal intersecting vane expander comprises a first rotor and at least one intersecting secondary rotor, wherein:
(a) said first rotor has a plurality of primary vanes positioned on a radially inner peripheral surface of said first rotor, with spaces between said primary vanes and said inside surface of said supporting structure defining a plurality of primary chambers;
(b) an intake port which permits flow of exhaust gas into said primary chamber and an exhaust port which permits exhaust of expanded exhaust gas out of said primary chamber;
(c) said secondary rotor has a plurality of secondary vanes positioned on a radially outer peripheral surface of said secondary rotor, with spaces between said secondary vanes and said inside surface of said supporting structure defining a plurality of secondary chambers;
(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and
(e) wherein the primary vanes positively displace the secondary vanes and expand the exhaust gas in the primary chambers.

11. The system according to claim 10, wherein the toroidal intersecting vane expander further comprises an expander rotor shaft through the axis of rotation of the first rotor wherein the expander drives the expander rotor shaft.

12. The system according to claim 11, wherein the expander rotor shaft is the main crank shaft.

13. The system according to claim 11, wherein the expander rotor shaft is the compressor rotor shaft.

14. The system according to claim 13, wherein the expander rotor shaft drives an electric generator operationally attached to said compressor.

15. The system according to claim 10, wherein the toroidal intersecting vane expander comprises a plurality of secondary rotors and is configured as a multistage expander.

16. The system according to claim 15, wherein the exhaust gas is heated between expansion stages or the expander is configured to provide cooled air for the engine through expansion of compressed air.

17. The system according to claim 16, wherein the heat from exhaust gas is used to heat compressed air in a heat exchanger.

18. The system according to claim 10, wherein the toroidal intersecting vane machine comprises a plurality of rotors and is configured to produce expanded exhaust gas at two or more distinct pressure ratios.

19. The system according to claim 1 further comprising a line recirculation of a portion of said exhaust gas to said air intake line.

20. The system according to claim 19 further comprising an EGR control valve operated so as to control the concentration of recirculated exhaust gas and air.

21. The system according to claim 10 comprising a controller to control at least one of the quantity of fuel injected, the quantity of recirculated exhaust gas, the quantity of air, the pressure of recirculated exhaust gas, and/or the pressure of air.

22. The system according to claim 1, wherein the air is compressed to a pressure between about 1.5 and about 2 atm.

23. The system according to claim 22, wherein the compressor rotor shaft rotates at the same speed as the main crank shaft.

24. The system according to claim 23, wherein the air is compressed to a substantially consistent pressure at variable rotation speeds of the compressor rotor shaft.

25. The system according to claim 13, where the compressor and expander are both on the crankshaft.

26. The system according to claim 13, where the compressor and expander are not on the main crankshaft.

27. The system according to claim 1, where the compressor pressure ratio is selected to to reduce the compression work of the engine.
